(19) United States
(12) Patent Application Publication
(10) Pub. No.: US 2011/0142535 A1
(43) Pub. Date: Jun. 16, 2011

(54) Multiple-core molded shell attachment and method of forming the same

(75) Inventors: Pal M. Molnar, St. Clair Shores, MI (US); Steven J. Wille, Macomb, MI (US); Tim E. Droege, Macomb, MI (US)

(73) Assignee: Novo Motor Acoustic Systems Inc.

(21) Appl. No.: 12/928,538

(22) Filed: Dec. 14, 2010

Related U.S. Application Data
(60) Provisional application No. 61/286,202, filed on Dec. 14, 2009.

(51) Int. Cl. F16B 7/00; B29C 45/00

(52) U.S. Cl. 403/220; 264/328.1; 403/361

(57) ABSTRACT

The present invention relates to an attachment feature for attaching a molded shell to another part, and a method of forming the same. More specifically, it relates to the formation of a molded attachment feature for attaching a molded shell, such as an engine cover, an air duct, or an electrical unit, to a supporting part, such as an engine block, a vehicle frame, or a battery tray. The attachment feature includes a first pocket defined in the molding process by a primary core and a second pocket defined in the molding process by a secondary core.

This application claims the benefit of U.S. Provisional Patent Application Ser. No. 61/286,202, entitled MULTIPLE-CORE MOLDED ATTACHMENT AND METHOD OF FORMING THE SAME, filed Dec. 14, 2009 to Pal Molnar, Steve Wille, and Tim Droege, and incorporated herein by reference.

### BACKGROUND OF THE INVENTION

1. Field of the Invention

The present invention relates to an attachment feature for attaching a molded shell to another part, and a method of forming the same. More specifically, it relates to the formation of a molded attachment feature for attaching a molded shell, such as an engine cover, an air duct, or an electrical unit, to a supporting part, such as an engine block, a vehicle frame, or a battery tray. The attachment feature includes a first pocket defined in the molding process by a primary core and a second pocket defined in the molding process by a secondary core.

2. Background of the Related Art

Commonly, an automobile engine is enclosed in a molded plastic cover. The aesthetic function (under-hood appearance or styling requirement) of this engine cover is believed to be exceptionally important criteria for the end-customers. Besides this, these covers often provide acoustic isolating (also referred to as Noise Vibration and Harshness or NVH-isolation) function as well. In addition to these main functions, they also need to fulfill the requirements of simplicity in high-volume manufacturing, assembly and serviceability. These covers are usually attached to the engine at several points by a ball-stud and a rubber grommet. The technological advances in the field of engine design and material development drive weight reduction, encouraging the use of smaller and more compact parts and decreasing the space between parts, which in turn reduces the clearance available for the attachment geometry. Attachment is often by way of an attachment “tower,” which provides an off-set by extending between the cover and the attachment point of the ball-stud.

This development generates additional requirements to the cover-side geometry of this attachment type. The clearance required by the currently widespread concept of a traditional attachment tower varies spatially depending on the direction; the smallest necessary clearance is in the direction from where the rubber grommet is assembled. Using it confines the vehicle-design engineers to an extremely narrow range of attachment feature orientations. In most cases, the final result is a sub-optimal compromise between the two main functions of the engine cover, e.g. the styling and the acoustic isolation.

### SUMMARY OF THE INVENTION

The multiple-core attachment feature described in this application disconnects the design requirements of styling and acoustic isolation and, thus, provides the designer the required freedom in styling. At the same time it keeps all other requirements simultaneously fulfilled, without any compromise in the final results. The shape and orientation of the primary core (or cores) can match the styling directions, while the shape and orientation of the secondary core (or cores) are aligned with the geometry of the mating parts. It can be used either by new designs or as a design modification of existing prototype and production tools. The mating and supporting parts can remain unchanged, as well as the originally-planned manufacturing, assembling and servicing procedures. These and other advantages of one or more aspects will become apparent from the following description and attached drawings.

The objective of this invention is to improve an elastically isolated mounting of a molded shell. The invention allows for the removable attachment of a molded shell to a sphere-shaped head on a support feature, such as a ball-stud, attached to a supporting part. A coupling element made of elastic material with a sphere-shaped opening attaches to the ball-stud through a predetermined geometric interlock, and connecting these sphere-shaped mating surfaces in a releasable way. A molded attachment feature extended from the molded shell base includes a pocket including a coupling element retaining feature for securing the coupling element. This attachment design provides a simple means for removably mounting a molded shell on a supporting part. The clearance requirements of this kind of attachment are highly dependant on the alignment of the attachment feature. The clearance to the supporting part and other surrounding parts typically allows only a narrow range of possible orientations, which often translates to design constraints of other functional or styling features. A multiple-core attachment feature solves this issue by separating the areas of different functions, thus simultaneously fulfilling multiple design requirements.

In accordance with one embodiment of a multiple-core attachment feature, the supporting part can be practically any vehicle part, such as an engine block, a vehicle frame or any other unit required to support other elements; the molded shell is a lightweight plastic part, such as engine cover, an air intake duct, or an electrical unit. The above-described geometric interlock comprises a circular or a horseshoe-shaped pocket with a circular or an angular groove on the molded shell, in which a coupling element fits into the opposite mating geometry. Having all other features like ribs and pockets aligned to their specific functionalities, such as weight reduction, stiffening, styling or clearance, the geometric interlock and the pocket for the decoupling element can be aligned according to it's own function and to the clearance of the surrounding parts.

To manufacture this geometry, the molding tool of the shell needs to have at least one secondary core or ejector block not contiguous to the main body or base of the molded shell. At least one primary core or ejector block is sandwiched between the first one and the main body or base of the molded shell. The end result is that all these cores and/or ejector blocks can be detached from the molded shell in different directions.

In one embodiment, the present invention is a single-piece molded attachment feature extending from a molded shell comprising a first pocket aligned in a primary direction and a second pocket aligned in a secondary direction, wherein the primary direction and the secondary direction are different directions. In this embodiment, the second pocket is a coupling element-holding pocket including a coupling element retaining feature adapted to retain a coupling element at least partially within the coupling element-holding pocket, and wherein the coupling element is capable of receiving and removably retaining a substantially spherical support feature. The attachment feature further comprises an over-push feature, such that deformation of the coupling element upon receiving the substantially spherical support feature is limited by contact with the over-push feature. In this embodiment, the first pocket is a weight reduction pocket or a plurality of weight reduction pockets and may include an inner stiffening rib. In this embodiment, the molded shell includes an A-side and a B-side opposite the A-side, and wherein the single piece molded attachment extends from the B side of the molded shell in a line of draw direction, and wherein the molded shell includes at least one of a concave A-side styling feature and an angled A-side styling feature. An angle measured between the primary direction and a plane perpendicular to the line of draw can be greater than 0 degrees. Preferably, the first pocket is located between the second pocket and the molded shell, and the first pocket is aligned with styling, stiffness and functional requirements of the molded shell, and wherein the second pocket is aligned with clearance requirements.

In another embodiment, the present invention is a method of manufacturing an injection molded attachment feature extending from a molded shell base comprising the steps of (a.) providing an A-side plate positioned adjacent an A-side of the molded shell base; (b.) providing a B-side plate positioned adjacent a B-side of the molded shell base, the B-side opposite the A-side, and the B-side plate including a cavity; (c.) providing a primary core, the primary core adapted to define a first pocket in the attachment feature, and the primary core adapted to fit within the cavity adjacent the molded shell base; (d.) providing a secondary core, the secondary core adapted to define a second pocket in the attachment feature, and the secondary core adapted to fit within the cavity adjacent the primary core; (e.) positioning the primary core and the secondary core within the cavity; (f.) forming the injection molded attachment feature within the cavity using injection molding means; (g.) separating the A-side plate from the molded shell base; (h.) separating the B-side plate from the molded shell base and the injection molded attachment feature in a line of draw direction; (i.) moving the primary core in a direction of primary core movement, whereby the first pocket is aligned with the direction of primary core movement; and (j.) moving the secondary core in a direction of secondary core movement, whereby the second pocket is aligned with the direction of secondary core movement; wherein the direction of primary core movement and the direction of secondary core movement are not identical, and wherein the primary core is positioned between the molded shell base and the secondary core such that the secondary core does not contact the molded shell base. In this other embodiment, an angle measured between the direction of primary core movement and the direction of secondary core movement can be acute or obtuse. Preferably, steps (h.), (i.), and (j.) occur substantially simultaneously. Also, at least one of the direction of primary core movement and the direction of secondary core movement may not be perpendicular to the line of draw.

In a further embodiment, the present invention is a method of manufacturing an injection molded attachment feature extending from a molded shell base comprising the steps of: (a.) providing an A-side plate positioned adjacent an A-side of the molded shell base; (b.) providing a B-side plate positioned adjacent a B-side of the molded shell base, the B-side opposite the A-side, and the B-side plate including a cavity; (c.) providing an ejector plate located remote from the B-side plate in a line of draw direction; (d.) providing a primary ejector block, the primary ejector block adapted to define a first pocket in the attachment feature, and the primary ejector block adapted to fit within the cavity adjacent the molded shell base; (e.) providing a primary ejector rod attached to the ejector plate, wherein the primary ejector rod is rigidly attached to the primary ejector block; (f.) providing a secondary ejector block, the secondary ejector block adapted to define a second pocket in the attachment feature, and the secondary ejector block adapted to fit within the cavity adjacent the primary core; (g.) providing a secondary ejector rod attached to the ejector plate, wherein the secondary ejector rod is rigidly attached to the secondary ejector block; (h.) positioning the primary ejector block and the secondary ejector block within the cavity; (i.) forming the injection molded attachment feature within the cavity using injection molding means; (j.) separating the A-side plate from the molded shell base in a direction opposition the line of draw direction; (k.) separating the B-side plate from the molded shell base and the injection molded attachment feature in the line of draw direction; (l.) moving the primary ejector rod relative to the ejector plate in a direction of primary slider movement, causing the primary ejector block to move in a direction of primary core movement such that the vectors of the primary slider movement and primary core movement are identical in relation to the molded shell base, whereby the weight reduction pocket is aligned with the direction of primary core movement; and (m.) moving the secondary ejector rod relative to the ejector plate in a direction of secondary slider movement, causing the secondary ejector block to move in a direction of secondary core movement such that the vectors of the secondary slider movement and secondary core movement are identical in relation to the molded shell base, whereby the second pocket is aligned with the direction of secondary core movement; wherein the direction of primary core movement and the direction of secondary core movement are not identical, and wherein the primary ejector block is positioned between the molded shell base and the secondary ejector block such that the secondary ejector block does not contact the molded shell base. In this further embodiment, an angle measured between the direction of primary core movement and the direction of secondary core movement may be acute or obtuse. Also, steps k, l, and m occur substantially simultaneously. In addition, the direction of primary core movement and the direction of secondary core movement may not be perpendicular to the line of draw.

### BRIEF DESCRIPTION OF THE DRAWINGS

FIG. 1A—Prior art attachment feature—assembled position;

FIG. 1B—Prior art attachment feature—exploded view;

FIG. 2A—Prior art molding tool—concept closed;

FIG. 2B—Prior art molding tool—concept open;

FIG. 3—Prior art traditional attachment tower;

FIG. 4—Prior art dented solution for undercuts;

FIG. 5—Prior art cutout solution for undercuts;

FIG. 6—Prior art slotted solution for undercuts;

FIG. 7A—Dual-core attachment feature—assembled position;

FIG. 7B—Dual-core attachment feature—exploded view;

FIG. 8A—Dual-core attachment feature—front view;

FIG. 8B—Dual-core attachment feature—side view;

FIG. 9A—Dual-core molding tool—concept closed;

FIG. 9B—Dual-core molding tool—cores closed;

FIG. 9C—Dual-core molding tool—cores open

FIG. 9D—Dual-core molding tool—concept open

FIG. 10A—Dual-core attachment feature with acute secondary angle—assembled position;

FIG. 10B—Dual-core attachment feature with acute secondary angle—exploded view;

FIG. 11A Dual-core attachment feature with obtuse secondary angle—assembled position;

FIG. 11B—Dual-core attachment feature with obtuse secondary angle—exploded view;

FIG. 12—Dual-core attachment feature with small primary angle; and

FIG. 13—Dual-core attachment feature with large primary angle.

### DETAILED DESCRIPTION

To clarify terms used herein, a core is a block used to define a shape in the molding process. In this case, a core is used to form a cavity or in a molded attachment feature during the molding process. An ejector block is a core operated by an ejector mechanism. The devices referred to herein as ejector blocks are also commonly referred to as “lifters” in the tooling industry

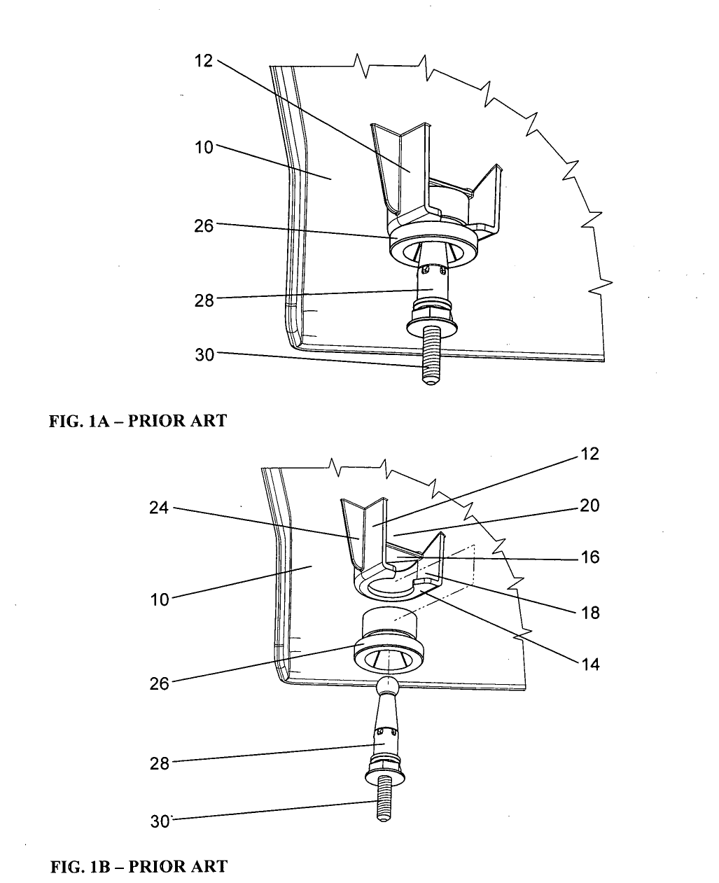

FIGS. 1A and 1B show a prior art embodiment of a commonly used attachment feature. In a typical embodiment, a molded shell may include several attachment features for attaching the molded shell to a supporting part using substantially identical or very similar structures.

A molded shell, for example a plastic engine cover, might need to be attached to a supporting part or carry several additional parts, like acoustic foams, bumpers and various caps, etc. All these parts are attached by various means to a molded shell base 10. A typical traditional attachment tower 12, a type of attachment feature, is formed as one single injection-molded piece, together with the molded shell base 10, by forming at least one coupling element-holding pocket 18, and optionally one or more weight reduction pockets 20 in the part.

During the assembly process, an elastic coupling element 26 is first snapped into the coupling element-holding pocket 18, held secure by a coupling element-retaining feature 14. The elastic coupling element 26 is often a rubber grommet, although other suitable elements may be used. A support feature 28, such as a ball-stud, is attached directly to a supporting part (not shown), typically through a plastic or metallic threaded surface 30. At the final step of the assembly process, the molded shell 10 is pushed toward the supporting part. The geometry of the attachment tower 12 allows the coupling element 26 to be stretched against the support feature 28, until the top surface of the rubber coupling element 26 touches an over-push feature 16 of the attachment tower 12. This contact limits the deformation of the coupling element 26, forcing an expansion to a sphere-shape opening of the rubber coupling element 26 up to a predetermined point, when it snaps onto the matching surface of the support feature 28. The disassembly process for service is exactly the opposite of the assembly process. For servicing the whole engine or just some components of it, typically only the last step is needed.

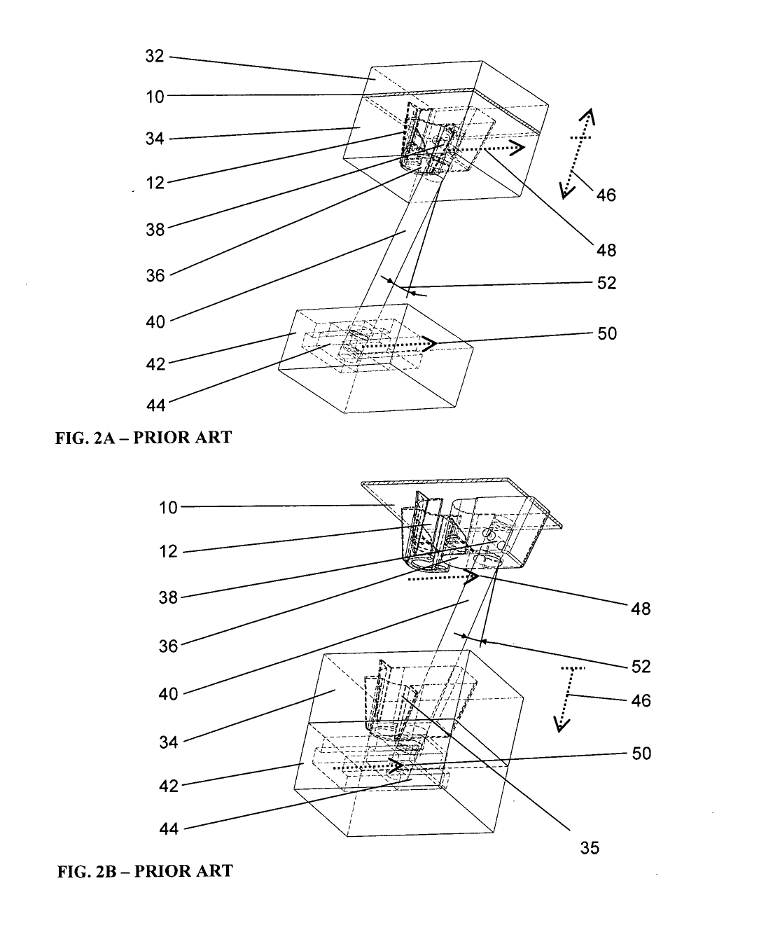

FIGS. 2A and 2B show a portion of a prior art design of the molded shell's injection mold tool using standardized components. One of the main challenges of this kind of attachment is the forming of the above-mentioned pockets 18, 20 shown in FIGS. 1A and 1B, more specifically, demolding the undercuts. These pockets 18, 20 are typically located distant from the edges of the molded shell, facing somewhat toward the center of the part. This makes the usage of direct sliding cores operated by angled columns in most cases unfeasible. The currently known best practice is to use an ejector system to move these cores, in the following manner.

FIG. 2A shows a prior art mold in a closed position during the injection and solidification process. FIG. 2B shows the same mold in an open position. An A-side plate 32 is held fixed against an A-side of a molded shell base 10. A B-side plate 34 includes a cavity 35, and is held fixed against a B-side of the molded shell base 10, with the cavity 35 adjacent the molded shell base 10. An ejector plate 42 remains apart from the B-side plate 34. An ejector block 36 is located in the cavity 35, defining an undercut to be formed in the attachment tower 12. Injected material is introduced into the cavity 35 using standard injection molding techniques, forming a molded part, in this case an attachment tower 12, on the molded shell base 10. Once the injected material solidifies, the A-side plate 32 of the mold is separated from the B-side plate 34 along the line of draw 46 direction, exposing the A-side of the molded shell base 10. In the next step of the ejection process, the ejector plate 42 moves along the line of draw 46 toward the B-side plate 34. A plurality of ejector pins (not shown) are assembled on the ejector plate 42 and extend in the direction of the line of draw 46. As the ejector plate 42 is moved toward the B-side plate 34, the ejector pins push the molded shell base 10 away from the B-side plate 34, which removes the attachment tower 12 from the cavity 35 and separates the B-side plate from the attachment tower 12. By each attachment tower 12, there is an angled ejector rod 40 attached to the ejector plate 42 through a slider mechanism 44, providing a mechanical connection between the ejector block 36 and the ejector plate 42. As the ejector plate 42 moves toward the B-side plate 34, the slider mechanism 44 urges the ejector rod 40 to slide along the direction of the slider movement 50, relative to the ejector plate 42. To form all the pockets 18 and 20 of the attachment tower 12, the ejector block 36 is rigidly attached to the angled ejector rod 40, typically by an ejector dowel 38. The angled ejector rod 40 passes through the cavity 35 of the B-side plate 34. As the ejector plate 42 moves towards the B-side plate 34, the ejector block 36 moves along the direction of the core movement 48, relative to the ejector plate 42, which removes the ejector block 36 from the attachment tower 12. This mechanism ensures that the vector of the slider movement 50 is exactly the same as the vector of the core movement 48, while the angle 52 of the angled ejector rod 40 remains constant. The amount of the movement of the B-side plate 34 and the ejector rod angle 52 defines the actual displacement of the ejector block 36 as the prior art mold transitions from a closed position, as shown in FIG. 2A, to an open position, as shown in FIG. 2B.

At the end of the ejection process, the prior art mold is in an open position, as shown in FIG. 2B. At this time, all the undercuts of the attachment tower 12 have been cleared, allowing it to be freely removed from the mold. The mold closing procedure comprises the same steps in reverse order.

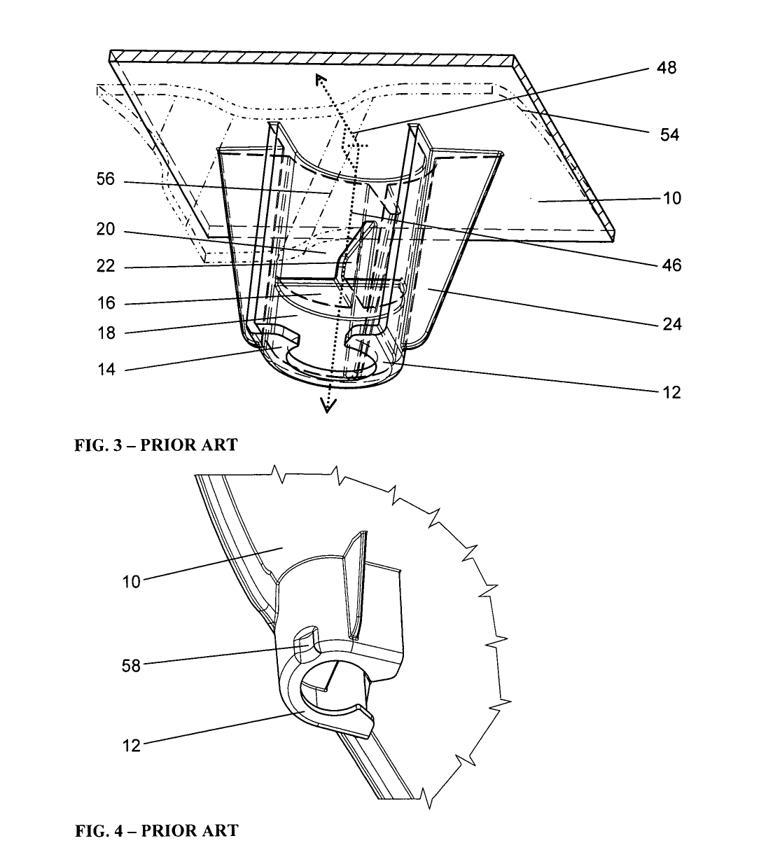

FIG. 3 shows some of the limitations caused by the traditional method in the prior art. By definition, the coupling element-retaining feature 14 and at least one part of the over-push feature 16 have to be substantially perpendicular to the line of draw 46 of the molding procedure. This also requires that the direction of the core movement 48 be substantially perpendicular to the line of draw 46. This core also needs to form the underlying surfaces of the molded shell base 10, as well as any number of inner stiffening ribs 22. To avoid or to reduce the amount of molding issues, such as warping or sink-marks on the A-side of the part, the wall thickness of the molded shell base 10 has to be constant. This is why currently the only feasible way to accommodate any possible concave A-side styling feature 54, or any angled A-side styling feature 56, is by reorienting the entire attachment tower 12 so that movement of the ejector block 36 does not bring it into contact with the raised B-side portion of an A-side concave or angled feature. This would require additional clearance from the attachment feature 12 on the B-side of the part, causing an increase of size and weight of the mating parts, ultimately resulting in a price-increase and unnecessary process complexity.

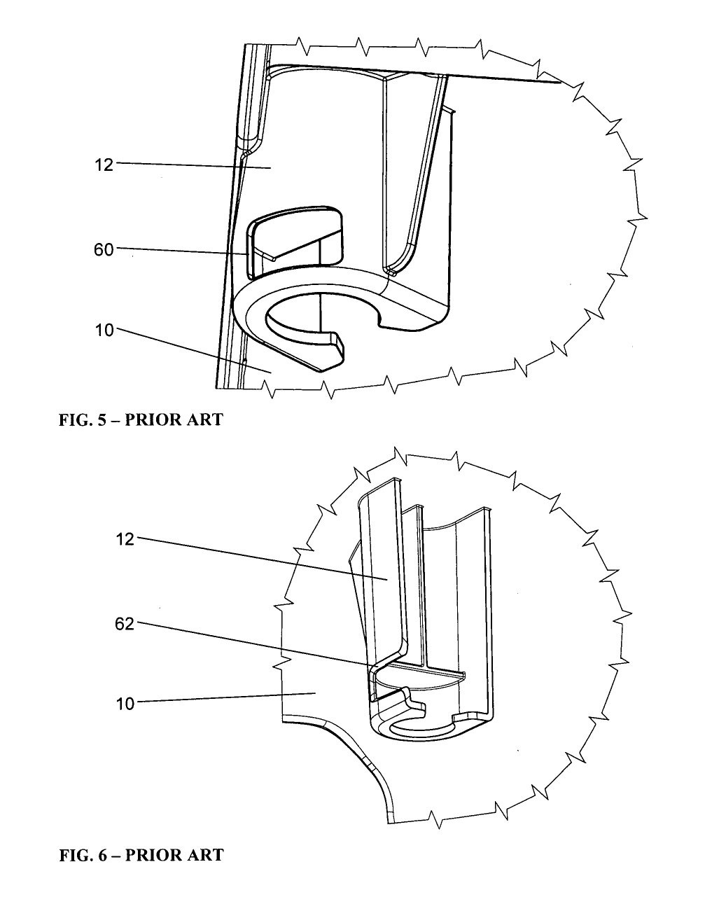

FIGS. 4 to 6 show several common prior art sub-optimal compromises between the limitations, such as a traditional attachment tower dent 58 (FIG. 4), a traditional attachment tower cutout 60 (FIG. 5), and a traditional attachment tower slot 62 (FIG. 6). All these solutions decrease the size and weight of the part, but sacrifice the stability and the rigidity of the attachment tower 12. Since they can only be used in cases where undercuts are at convenient locations and/or if they are properly aligned with the direction of the core movement 48, typically some additional design or functionality sacrifices may also be required.

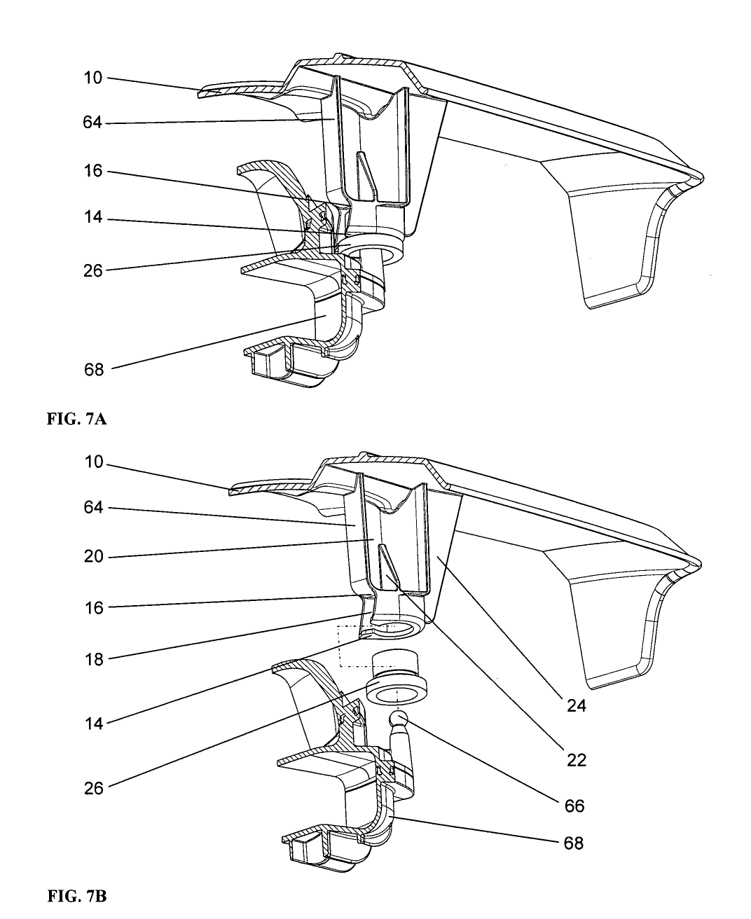

Turning from the prior art to the present invention, FIGS. 7A and 7B show a partial view of a typically critical engine cover environment. A substantially spherical support feature 66 is formed as part of the supporting portion of the engine block 68. Other areas of this part are very close to the attachment area; the minimal dynamic clearance can be obtained only by aligning the dual-core attachment feature 64 exactly with these surfaces. However, the predetermined geometry of the molded shell base 10 does not allow the second, or coupling element-holding, pocket 18 and the first, or weight reduction, pocket 20 to be formed in the same direction.

FIGS. 7A and 7B show a first embodiment out of many possible embodiments of the multiple-core attachment feature described in this application. The shown design takes advantage of a dual-core attachment feature concept, using several of the components, such as the elastic coupling element 26, and portions of the assembly and disassembly processes similar to the traditional concepts described above. The coupling element-retaining feature 14 and the over-push feature 16 are shaped different from all the prior-art embodiments, without sacrificing any functionality, stability or other similarly important design qualities. In the present invention, the over-push feature 16 is preferably a protrusion, rib, mullion, post, surface, or other structure capable of restricting the deformation of the coupling element 26.

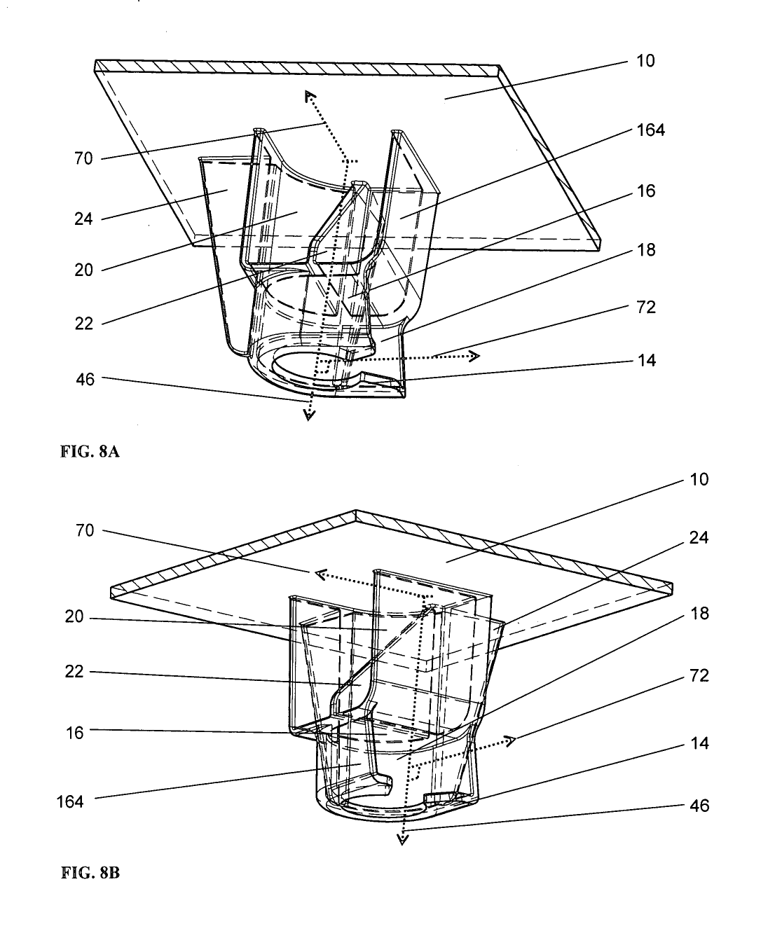

FIGS. 8A and 8B show a second embodiment of a dual-core attachment feature 164. The second embodiment is substantially similar to the first embodiment, except the first pocket 20 is rotated 180 degrees between the embodiments, and the inner stiffening rib 22 extends the full height of the first pocket 20. The first pocket 20 is aligned with the direction of a primary core movement 70, while the second pocket 18 is aligned with the direction of a secondary core movement 72. The primary core defines the first, weight reduction, pocket 20 and is also responsible for forming any number of the inner stiffening ribs 22. The secondary core defines the second, coupling element-holding, pocket 18 and provides both the coupling element-retaining feature 14 and the over-push feature 16. One or more outer stiffening ribs 24, if needed for stability purposes, may be formed by an additional core (not shown here), or by corresponding geometry in the cavity 35.

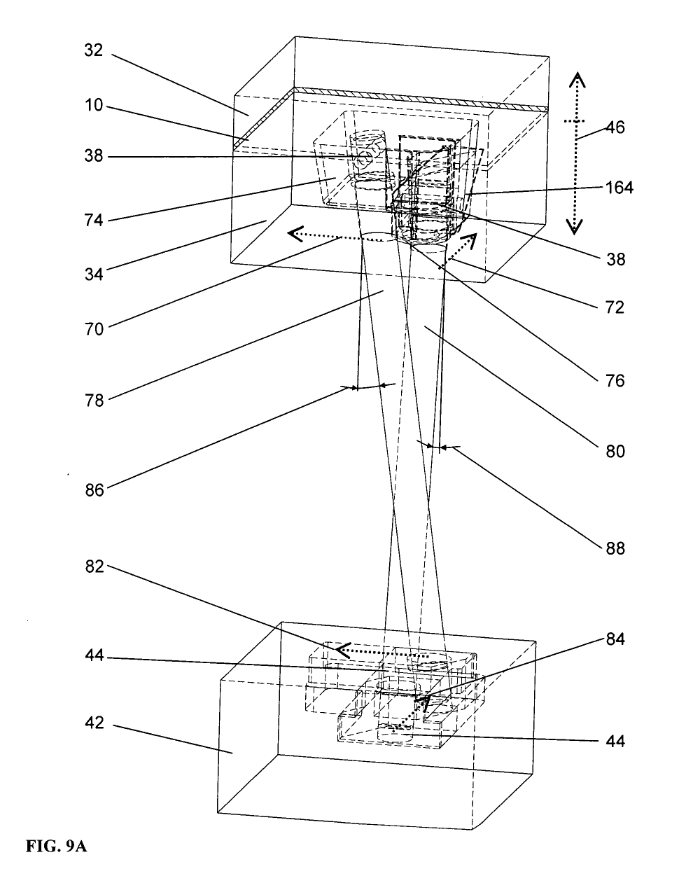

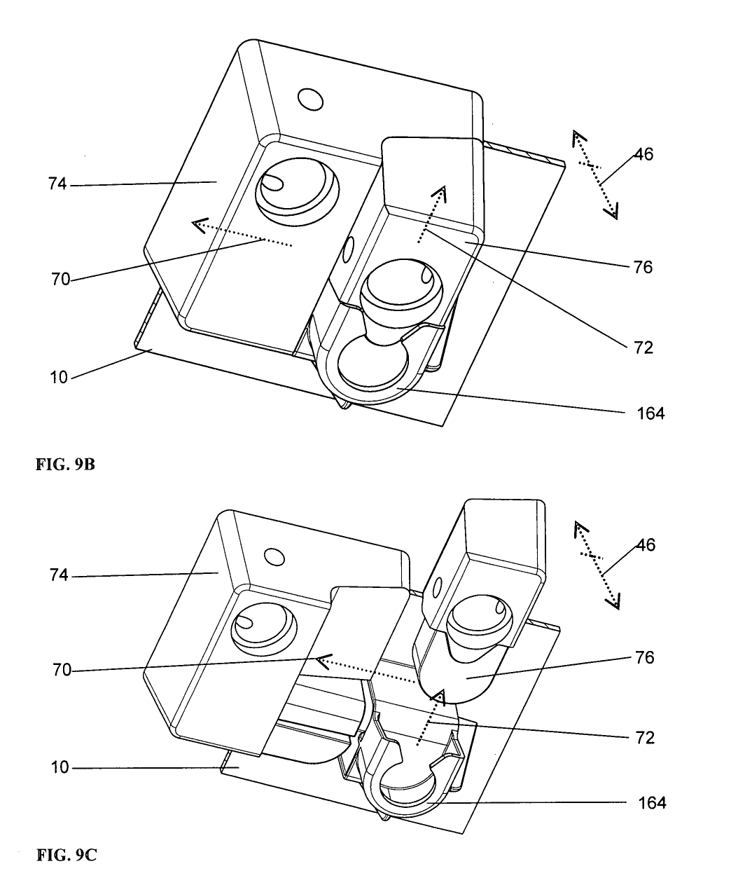

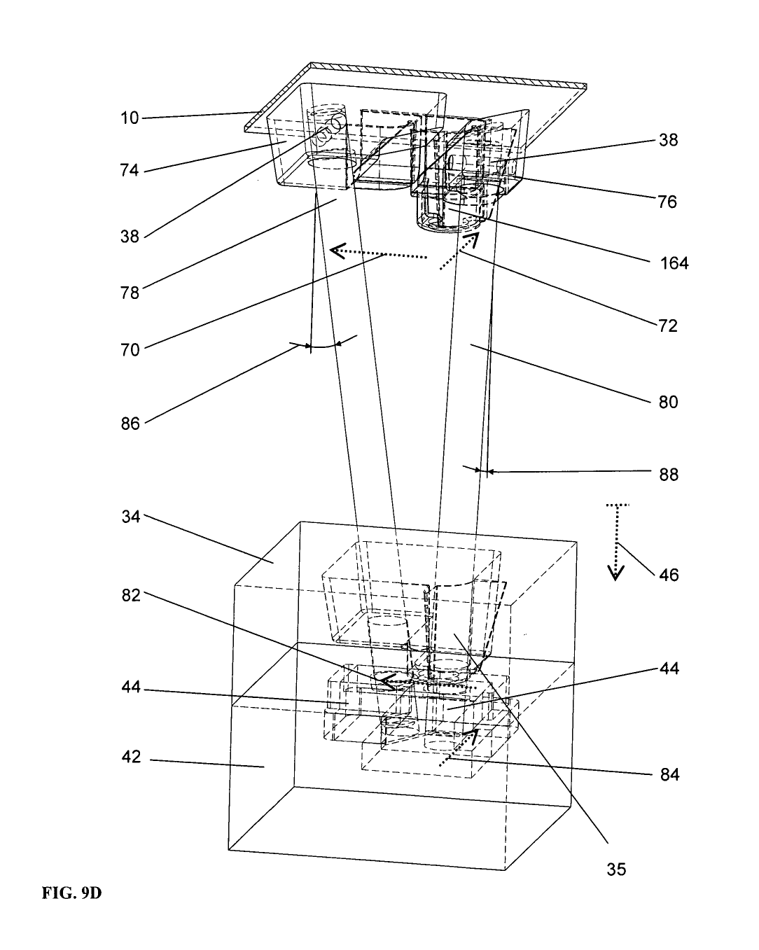

FIGS. 9A to 9D show one possible manufacturing process of a dual-core attachment feature 164. The process includes at least two separate ejector blocks and, during the ejection process, each of moves simultaneously in different directions. For simplicity, the process described here uses only one primary and only one secondary ejector blocks. However the design can accommodate any number of ejector blocks, without changing the manufacturing process.

The process includes providing an A-side plate 32 positioned adjacent an A-side of the molded shell base 10 and providing a B-side plate 34 positioned adjacent a B-side of the molded shell base 10. The B-side plate 34 includes a cavity 35. The B-side of the molded shell base 10 is opposite the A-side. The process includes providing a primary core 74 adapted to define a first pocket 20 in the attachment feature to be formed and a secondary core 76 adapted to define a second pocket 18 in the attachment feature to be formed. The primary core 74 and secondary core 76 are adapted to fit within a cavity 35 in the B-side plate 34 such that the primary core 74 is adjacent to the molded shell base 10 and the secondary core 76 is adjacent the primary core 74, but does not contact the molded shell base 10. Both cores 74, 76 are positioned within the cavity 35 to begin the manufacturing process.

Injected material is introduced into the cavity 35 using standard injection molding techniques, forming an attachment feature 164 as a single part with the molded shell base 10. Once the injected material solidifies, the A-side plate 32 of the mold is separated from the molded shell base 10 along the line of draw 46, exposing the A-side of the molded shell base 10.

During the ejection process, the ejector plate 42 moves along the line of draw 46 towards the B-side plate 34. Assembled to the ejector plate 42, several ejector pins (not shown) move along the line of draw 46, pushing the attachment feature 164 out of the cavity 35 and separating the B-side plate 34 from the molded shell base 10 and molded attachment feature 164. By each dual-core attachment feature 164, there is a primary angled ejector rod 78 attached to the ejector plate 42 through a slider mechanism 44. This slider mechanism 44 urges the primary ejector rod 78 to slide along the direction of a primary slider movement 82, relative to the ejector plate 42. To form any number of first pockets 20, a primary ejector block 74 is rigidly attached to the primary angled ejector rod 78, typically by an ejector dowel 38. Consequently the primary ejector block 74 moves along the direction of the primary core movement 70, relative to the ejector plate 42. This mechanism ensures that the vector of the primary slider movement 82 is exactly the same as the vector of the primary core movement 70, in relation to the molded shell base 10, while the primary ejector rod angle 86 remains constant. The amount of the movement of the ejector plate 42 and the primary ejector rod angle 86 defines the actual displacement of the primary ejector block 74.

Correspondingly, by each dual-core attachment feature 164, there is also a secondary angled ejector rod 80 attached to the ejector plate 42 through another slider mechanism 44. This slider mechanism 44 urges the secondary ejector rod 80 to slide along the direction of a secondary slider movement 84, relative to the ejector plate 42. To form the second pocket 18, a secondary ejector block 76 is rigidly attached to the secondary angled ejector rod 80, typically by an ejector dowel 38. Consequently the secondary ejector block 76 moves along the direction of the secondary core movement 72, relative to the ejector plate 42. This mechanism ensures that the vector of the secondary slider movement 84 is exactly the same as the vector of the secondary core movement 72, in relation to the molded shell base 10, while the secondary ejector rod angle 88 remains constant. The amount of the movement of the ejector plate 42 and the secondary ejector rod angle 88 defines the actual displacement of the secondary ejector block 76.

The secondary ejector block 76 is not contiguous to the molded shell base 10; the primary ejector block 74 is sandwiched between these two components. This is what allows the direction of secondary core movement 72 to be practically in any direction, while the above-mentioned design requirements limit only the feasible range of direction of the primary core movement 70. The ratio of the amount of the primary core movement 70 and the secondary core movement 72 is defined by the ratio of the tangent values of the primary ejector rod angle 86 and of the secondary ejector rod angle 88.

At the end of the ejection process, all the undercuts of the molded part have been cleared, allowing it to be freely removed from the mold. The mold closing procedure comprises the same steps in reverse order. There are various mechanisms in praxis for the ejector sliders; this aspect is not part of the scope, neither part of the limitations of this application. The multiple-core attachment feature can be used without regard to the actual ejector slider mechanism; we have presented this part of the drawing only for the purpose of clarity.

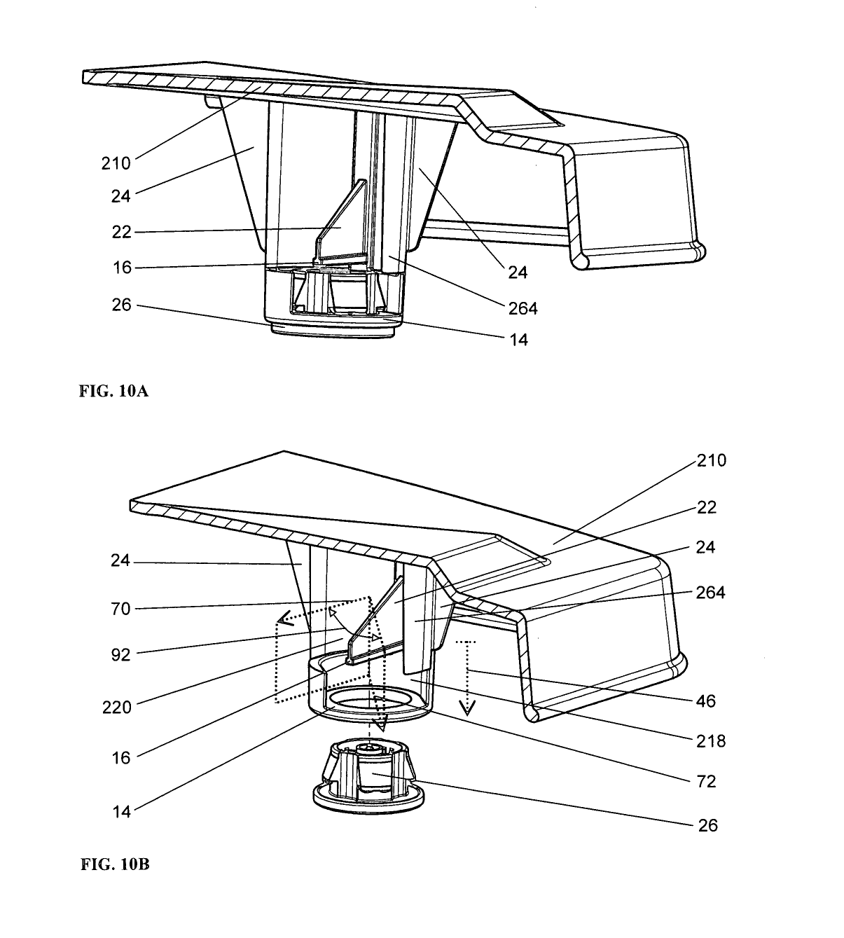

FIGS. 10A and 10B show a third embodiment of the attachment feature 264 extending from a molded shell base 210. The coupling element 26 used here is to be assembled axially, through a round hole of the coupling element-retaining feature 14. The over-push feature 16 is reduced to a smaller surface in the middle area of the dual-core attachment feature 64, supported by an inner stiffening rib 22. In this embodiment the coupling element-holding pocket 218 and the weight reduction pocket 220 are not completely separated. The angle measured between the primary core movement 70 and the secondary core movement 72 is referred to as the secondary angle 92. Although this angle has been shown as substantially 90 degrees in the embodiments depicted in FIGS. 7A-9D, any angle may be used. In the embodiment depicted in FIGS. 10A and 10B, the secondary angle is an acute angle.

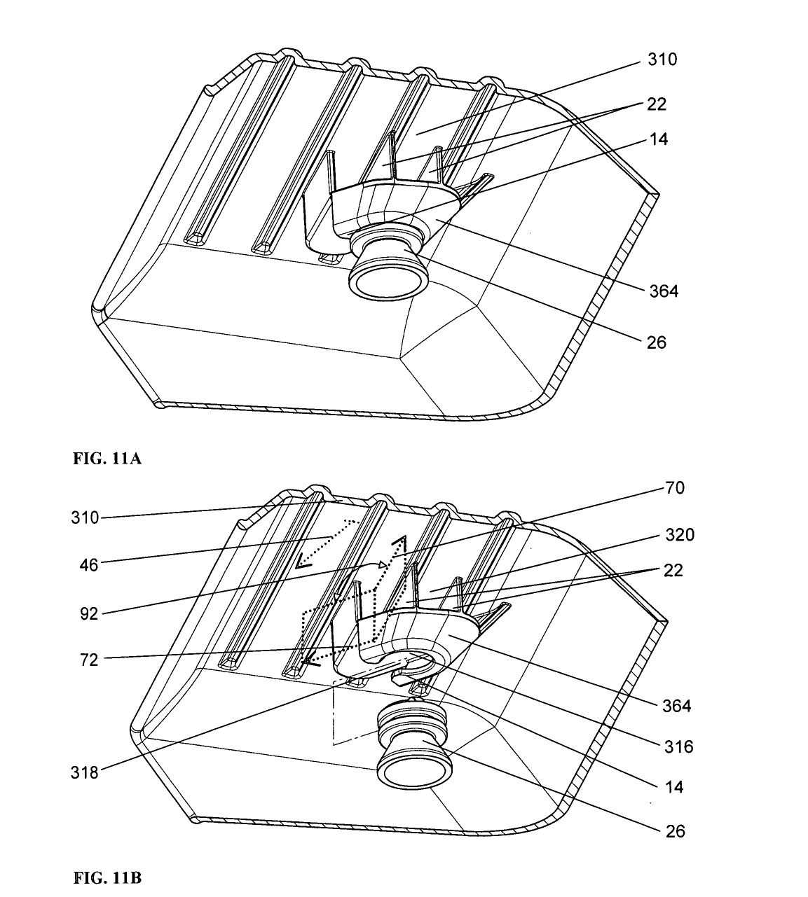

FIGS. 11A and 11B show a fourth embodiment of attachment feature 364 extending from a molded shell base 310. The coupling element 26 is to be assembled laterally to the coupling element-retaining feature 14, which is in this case a socket with angular groove. The over-push feature 316 covers the full area of the secondary core (not shown here). Two inner stiffening ribs 22 support the dual-core attachment feature 364. In this embodiment the line of draw 46 is not parallel to the ball-stud direction (not shown here). The secondary angle 92, measured between the primary core movement 70 and the secondary core movement 72, is, in this embodiment, an obtuse angle.

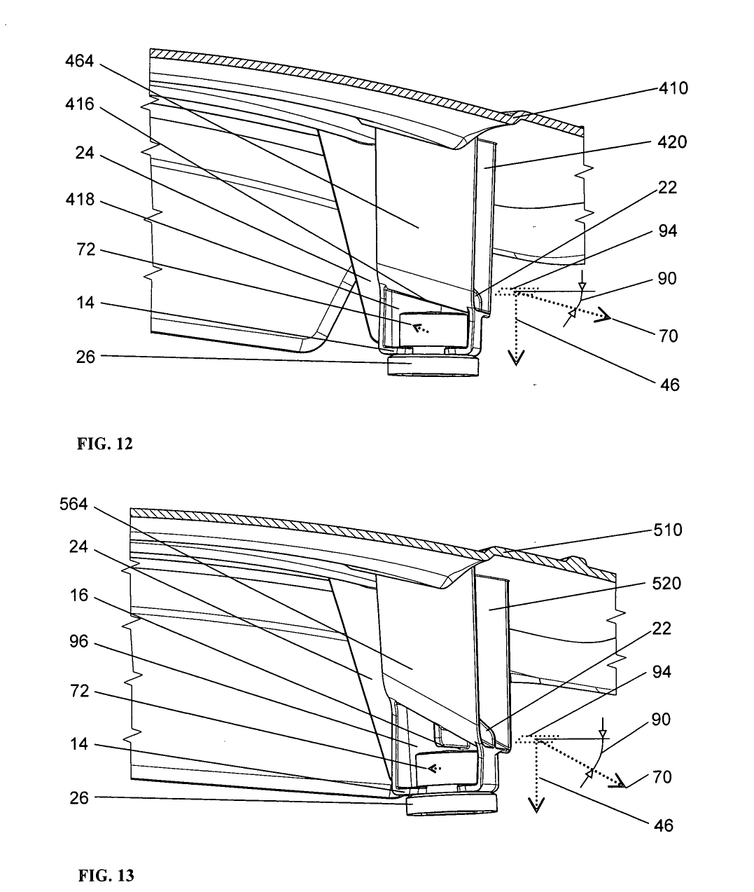

FIG. 12 shows a fifth embodiment of the dual core attachment feature 464 extending from a molded shell base 410. The angle measured between the direction of primary core movement 70 and a plane perpendicular to the line of draw 46 is called the primary angle 90. The primary angle 90 is substantially 0 degrees in the described first, second, third, and fourth embodiments. The primary angle 90 in this embodiment is greater than 0 degrees, providing an angled pocket 420. In this embodiment, the direction of secondary core movement 76 is perpendicular to the line of draw. The wall between the coupling element-holding pocket 418 and the weight reduction pocket 420 is angled at an angle equal to the primary angle 90. Since this wall fulfills the function of an over-push feature 416, the primary angle 90 should be selected to provide adequate clearance around the coupling element 26. Otherwise it would block the dynamic movements, and consequently it would degrade the isolation of the attachment.

FIG. 13 shows a sixth embodiment of a dual-core attachment feature 564 extending from a molded shell base 510. In this embodiment, the primary angle 90 is significantly larger than in the previous embodiments, providing a steeper angle between the first pocket 520 and second pocket 518. In this embodiment an over-push feature 96 serves to avoid the over-push during the assembly process. In all other aspects the part is identical to the one shown on FIG. 12.

Accordingly, the reader will see that the multiple-core molded shell attachment provides a cost-effective solution for the usual clearance limitations of any attachment, without sacrificing any functionality, stability or other similarly important design qualities. It can be assembled or removed just as easily as the traditional tower attachment method, however it gives the designer the freedom of feature orientation, thus allowing a weight-optimized fully function-oriented design. Also, the above described method of forming this geometry proved to be easily applicable, and equally feasible for prototyping, and for low-volume and high-volume mass production as well.

Although the description above contains many specificities, the given examples should not be construed as limiting the scope of the embodiments but as merely providing illustrations of some of presently preferred and possible embodiments. For example, the core-removal directions can be aligned freely, the shapes and sizes of each of the cores can be adjusted, according to the actually specific requirements. The shown mechanism that operates different parts of the mold can be replaced by any mechanism used for this purpose. The attached shell can be made of plastic, steel, aluminum, or any similarly molded material, the isolating element can be made of rubber, plastic, or any kind of elastic material. The attached part can be practically any part that needs to be decoupled, easy to attach and detach, as well as the supporting part can be any other part that can provide the required support.

What is claimed is:

1. A single-piece molded attachment feature extending from a molded shell, comprising:
a first pocket aligned in a primary direction; and
a second pocket aligned in a secondary direction;
wherein said primary direction and said secondary direction are different directions.

2. The single-piece molded attachment feature of claim 1, further comprising an elastic coupling element secured to said attachment feature, said coupling element capable of receiving and removably retaining a support feature.

3. The single-piece molded attachment feature of claim 2, wherein said second pocket includes a coupling element retaining feature adapted to retain said coupling element at least partially within said second pocket.

4. The single-piece molded attachment feature of claim 3, further comprising an over-push feature, such that deformation of said coupling element upon receiving said support feature is limited by contact with said over-push feature.

5. The single-piece molded attachment feature of claim 1, wherein said first pocket is a weight reduction pocket.

6. The single-piece molded attachment feature of claim 5, wherein said weight reduction pocket includes an inner stiffening rib.

7. The single-piece molded attachment feature of claim 5, wherein said weight reduction pocket is a plurality of weight reduction pockets.

8. The injection-molded attachment feature of claim 1, wherein said molded shell includes an A-side and a B-side opposite said A-side, and wherein said single piece molded attachment extends from said B side of said molded shell in a line of draw direction, and wherein said molded shell includes at least one of a concave A-side styling feature and an angled A-side styling feature.

9. The single-piece molded attachment feature of claim 8, wherein an angle measured between said primary direction and a plane perpendicular to said line of draw is greater than 0 degrees.

10. The single-piece molded attachment feature of claim 8, wherein said first pocket is located between said second pocket and said molded shell.

11. The single-piece molded attachment feature of claim 1, wherein said first pocket is aligned with styling, stiffness and functional requirements of said molded shell, and wherein said second pocket is aligned with clearance requirements.

12. A method of manufacturing an injection molded attachment feature extending from a molded shell base comprising the steps of:
a. providing an A-side plate positioned adjacent an A-side of said molded shell base;
b. providing a B-side plate positioned adjacent a B-side of said molded shell base, said B-side opposite said A-side, and said B-side plate including a cavity;
c. providing a primary core, said primary core adapted to define a first pocket in said attachment feature, and said primary core adapted to fit within said cavity adjacent said molded shell base;
d. providing a secondary core, said secondary core adapted to define a second pocket in said attachment feature, and said secondary core adapted to fit within said cavity adjacent said primary core;
e. positioning said primary core and said secondary core within said cavity;
f. forming said injection molded attachment feature within said cavity using means for injection molding;
g. separating said A-side plate from said molded shell base;
h. separating said B-side plate from said molded shell base and said injection molded attachment feature in a line of draw direction;
i. moving said primary core in a direction of primary core movement, whereby said first pocket is aligned with said direction of primary core movement; and
j. moving said secondary core in a direction of secondary core movement, whereby said second pocket is aligned with said direction of secondary core movement;
wherein said direction of primary core movement and said direction of secondary core movement are not identical, and wherein said primary core is positioned between said molded shell base and said secondary core such that said secondary core does not contact said molded shell base.

13. The method of manufacturing an injection molded attachment feature extending from a molded shell base of claim 12, wherein an angle measured between said direction of primary core movement and said direction of secondary core movement is acute.

14. The method of manufacturing an injection molded attachment feature extending from a molded shell base of claim 12, wherein an angle measured between said direction of primary core movement and said direction of secondary core movement is obtuse.

15. The method of manufacturing an injection molded attachment feature extending from a molded shell base of claim 12, wherein steps h, i, and j occur substantially simultaneously.

16. The method of manufacturing an injection molded attachment feature extending from a molded shell base of claim 12, wherein at least one of said direction of primary core movement and said direction of secondary core movement is not perpendicular to said line of draw.

17. A method of manufacturing an injection molded attachment feature extending from a molded shell base comprising the steps of:
a. providing an A-side plate positioned adjacent an A-side of said molded shell base;
b. providing a B-side plate positioned adjacent a B-side of said molded shell base, said B-side opposite said A-side, and said B-side plate including a cavity;
c. providing an ejector plate located remote from said B-side plate in a line of draw direction;
d. providing a primary ejector block, said primary ejector block adapted to define a first pocket in said attachment feature, and said primary ejector block adapted to fit within said cavity adjacent said molded shell base;
e. providing a primary ejector rod attached to said ejector plate, wherein said primary ejector rod is rigidly attached to said primary ejector block;
f. providing a secondary ejector block, said secondary ejector block adapted to define a second pocket in said attachment feature, and said secondary ejector block adapted to fit within said cavity adjacent said primary core;
g. providing a secondary ejector rod attached to said ejector plate, wherein said secondary ejector rod is rigidly attached to said secondary ejector block;
h. positioning said primary ejector block and said secondary ejector block within said cavity;
i. forming said injection molded attachment feature within said cavity using means for injection molding;
j. separating said A-side plate from said molded shell base in a direction opposition said line of draw direction;
k. separating said B-side plate from said molded shell base and said injection molded attachment feature in said line of draw direction;
l. moving said primary ejector rod relative to said ejector plate in a direction of primary slider movement, causing said primary ejector block to move in a direction of primary core movement such that the vectors of the primary slider movement and primary core movement are identical in relation to said molded shell base, whereby said weight reduction pocket is aligned with the direction of primary core movement; and
m. moving said secondary ejector rod relative to said ejector plate in a direction of secondary slider movement, causing said secondary ejector block to move in a direction of secondary core movement such that the vectors of the secondary slider movement and secondary core movement are identical in relation to said molded shell base, whereby said second pocket is aligned with the direction of secondary core movement;
wherein the direction of primary core movement and the direction of secondary core movement are not identical, and wherein said primary ejector block is positioned between said molded shell base and said secondary ejector block such that said secondary ejector block does not contact said molded shell base.

18. The method of manufacturing an injection molded attachment feature extending from a molded shell base of claim 17, wherein an angle measured between said direction of primary core movement and said direction of secondary core movement is acute.

19. The method of manufacturing an injection molded attachment feature extending from a molded shell base of claim 17, wherein an angle measured between said direction of primary core movement and said direction of secondary core movement is obtuse.

20. The method of manufacturing an injection molded attachment feature extending from a molded shell base of claim 17, wherein steps k, l, and m occur substantially simultaneously.

21. The method of manufacturing an injection molded attachment feature extending from a molded shell base of claim 17, wherein at least one of said direction of primary core movement and said direction of secondary core movement is not perpendicular to said line of draw.

22. The method of manufacturing an injection molded attachment feature extending from a molded shell base of claim 17, wherein said second pocket includes a coupling element retaining feature adapted to retain a coupling element at least partially within said second pocket.
